(19) United States
(12) Patent Application Publication
(10) Pub. No.: US 2014/0160065 A1
(43) Pub. Date: Jun. 12, 2014

(54) TIME SLOT SCANNING METHOD ENABLING THE CAPACITIVE TOUCH SCREEN TO IMPLEMENT MULTIPLE SCANNING MODES

(71) Applicants: JK Zhang, Shenzhen (CN); Wenyong Long, Shenzhen (CN)

(72) Inventors: JK Zhang, Shenzhen (CN); Wenyong Long, Shenzhen (CN)

(21) Appl. No.: 13/956,830

(22) Filed: Aug. 1, 2013

(30) Foreign Application Priority Data
Aug. 1, 2012 (CN) 201210271003.X

(51) Int. Cl. G06F 3/044

(52) U.S. Cl. CPC G06F 3/044
USPC 345/174

(57) ABSTRACT

A time slot scanning method that enables the capacitive touch screen to implement multiple scanning modes, where the said capacitive touch screen comprises the capacitance matrix and data processing modules that are electrically connected thereto; the said scanning method refers to a data acquisition mode where the signal scanning is initiated in a cycle and the received data generated due to scanning are acquired. The present invention enables the touch screen to execute multiple scanning modes with the time slot scanning method. Under the circumstances where the master scanning mode is executed, the scanning course of the slave scanning mode will be inserted in sections into the scanning course of the master scanning mode. Through the alternate use of the master scanning mode and slave scanning mode, the present invention is able to utilize the strengths of the master scanning and slave scanning are utilized to solve the issue that fails to be resolve by only one scanning mode used; in the meantime, the alternate use of the master scanning mode and slave scanning mode ensures the homogeneity of the data acquisition time, thus enabling the reliability of data; only part of the slave scanning mode is executed, so as to minimize the additional time consumption.

The present application claim priority of Chinese patent application Serial No. 201210271003.X, filed Aug. 1, 2012, the content of which is hereby incorporated by reference in its entirely.

### TECHNICAL FIELD

The present invention relates to the data acquisition method, in particular, to the method of processing the data obtained from the sensing of the touch screen.

### BACKGROUND ART

The capacitive touch screen with prior art comprises the capacitance matrix made from electrode plates as well as the data processing module electrically connected thereto. The said data processing module judges the capacitance value variation points or areas of the capacitance matrix by the means that scanning is initiated and feedback data are received at the receiving port of such data processing module. Furthermore, it will determine the data on coordinates of the position touched by the touch screen, thus supply input data to the device equipped with such touch screen. The said touch screen can sense the capacitance variations on the touch screen in a real-time manner in the set scanning mode. If only one fixed circuit and scanning parameter are used, it may pose a risk of scanning failure. For instance, when the frequency bands of external noise and scanning frequency coincide, the system will be severely disturbed, thus generating misdate. Therefore, the use of a scanning mode based on only one fixed circuit and scanning parameter fails to be applicable to all working conditions of the touch screen, which may be inconvenient for users. In order to overcome the defect arising from the use of one scanning mode, the scanning mode commonly used with prior art include the triple-frequency scanning mode and scanning mode of switching scanning frequency. But the scanning mode for the capacitive touch screen with prior art has the following defects and shortcomings:

1. Although the use of the triple-frequency scanning mode has some antinoise advantage, it consumes long working time and has high working power dissipation; in respect of noises with high amplitude, as noises have caused the circuit input stage to be saturated, the said triple-frequency scanning mode will lose the antinoise ability. As a result, this triple-frequency scanning mode has its limitations; moreover, when the triple-frequency scanning mode is used, it is necessary to respectively optimize parameters of circuits corresponding to triple frequency. Its finished products will incur huge costs. Besides, base data and differential data will be reserved for triple frequency, and there are more demands for the storage space of the touch screen;

2. If the scanning mode of switching scanning frequency is utilized, the scanning frequency can be switched when some frequency is disturbed; but it is not easy to practically use the said scanning mode of switching frequency; if Frequency 1 is disturbed, and suppose that the system has Frequency 2 available to be selected, it is difficult to know about the disturbance of Frequency 2 before the system is switched to Frequency 2; therefore, it may pose higher risks arising from the switching to Frequency 2; like the scanning with Frequency 1, it is likely to be disturbed; furthermore, Frequency 1 and Frequency 2 have different cycles. It is possible that the noise of frequency is sampled when noises of Frequency 2 are higher, while the switching to Frequency 2 happens, noises themselves will become lower, which will cause the scanning mode with Frequency 1 and scanning mode with Frequency 2 failed to be referenced and compared in same conditions. This will probably lead to misjudgment. Accordingly, the use of the scanning mode with Frequency 2 fails to alleviate noises as well.

The present invention aims at seeking a method that is more effective than the aforementioned method and utilizes the scanning mode based on multiple different scanning circuits or parameters. One of its applications is to strengthen the antinoise ability for the system.

### CONTENT OF THE INVENTION

In view of the above-described problems, the aim of the invention are to avoid defeats in the prior art and to provide a time slot scanning mode enabling the capacitive touch screen to execute multiple scanning modes. Under the circumstances of executing the master scanning mode, the slave scanning mode is simultaneously executed. The slave scanning mode can play the role of detection or replacement, so as to counteract weakness of the master scanning mode, thus suppressing noises and enabling the touch screen to be suitable for multiple applications.

The purpose of the invention is achieved by the following technical schemes:

A time slot scanning method enabling the capacitive touch screen to implement multiple scanning modes is executed. The said capacitive touch screen comprises the capacitance matrix and the data processing module electrically connected thereto. The said scanning mode refers to the data acquisition mode where the signal scanning is initiated in a cycle and the received data generated due to scanning are acquired. The said method comprises the following steps:

A. The said capacitive touch screen is equipped with hardware and software, enabling it to support the completion of multiple N+1 scanning modes, N≧1;

B. One of N+1 scanning modes as stated in Step A is chosen to be set as the master scanning mode for the said touch screen, and other scanning modes thereof are respectively set as No. 1 slave scanning mode, No. 2 slave scanning mode . . . No. N slave scanning mode;

The said master scanning mode obtains a master scanning data frame in its own master scanning cycle T_{P}; the said various slave scanning modes respectively obtain a slave scanning data frame in their respective own slave scanning cycles T₁, T₂, . . . , T_{N};

C. The divided scanning is used to enable various slave scanning modes to obtain their respective slave scanning data, namely, the Mi section of scanning data subframes that are obtained through the unrepeatable time division scanning in the No. i slave scanning mode make up the No. i slave scanning data, i=1, 2, . . . , N; Mi represents the quantity of scanning data subframes for the No. i slave scanning mode, Mi≧1; Suppose j=1, 2, . . . , Mi, the subframe scanning cycle used for obtaining the No. ij scanning data subframe in the No. i slave scanning mode is tij, then:

$${\sum }_{j = 1}^{{M}_{i}} {t}_{ij} = {T}_{i} ;$$

D. In a scanning cycle T, a master scanning data frame is obtained in a master scanning cycle T_{P}, and the respective sections of the No. ij subframe scanning cycle tij for various slave scanning modes are used to obtain the N No. ij scanning data subframe. i.e. T=T_{P}+t₁ⱼ+t₂ⱼ+ . . . +t_{Nj}; that is to say, as for the No. i slave scanning mode, both the Mi master data frame and a No. i slave scanning data frame are obtained after Mi scanning cycles T have passed.

A time slot scanning mode means that the slave scanning mode of the executed part is inserted into the time slots between two master scanning modes, the said Step D further comprises the following substeps:

D1. In a scanning cycle T, first a master scanning data frame is obtained in a master scanning cycle T_{P}, and then N No. ij scanning data subframes are obtained in the respective sections of subframe scanning cycles tij for various slave scanning modes.

Specifically speaking, the said substep D1 further comprises the following substeps:

D11. Suppose i=1 and the segmented counting variation for slave scanning as xᵢ, and set x₁=x₂= . . . =x_{N}=1;

D12. A master scanning data frame is obtained in the master scanning mode after a master scanning cycle T_{P} passes;

D13. Suppose j=xᵢ, the No. ij scanning data subframe is obtained in the No. i slave scanning mode after a subframe scanning cycle tᵢⱼ passes;

D14. Judge whether xᵢ equals Mᵢ;

If xi=Mᵢ, set xᵢ as 1;

If xi≠Mᵢ, set the value of xᵢ+1 as the current value of xᵢ;

D15. Judge whether i equals N;

If i=N, set the value of i as 1 and execute Step D12;

If i≠N, set the value of i+1 as the current value of and execute Step D13.

Another time slot scanning mode means that the time slot is set in the course of executing the master scanning mode in a cycle and the slave scanning mode of the executed part is inserted into such time slot. The said Step D further comprises the following substeps:

D2. The master scanning data are obtained by using the divided scanning in the said master scanning mode, thus enabling the composition of the master subsection of scanning data completed by Q sections of master subsection scanning cycles; the composition of various scanning data subframes can also be achieved through the subdivided scanning, enabling the composition of the scanning data subframe completed by the subsection subframe scanning cycle for the No. ij scanning data subframe;

In a scanning cycle T, the following processes are executed in cycles for Q times:

First a master subsection of scanning data is obtained in the master subsection scanning cycle, and then N subsections of scanning data subframes are obtained in respective sections of subframe scanning cycles for various subscanning modes.

Specifically speaking, the said Substep D2 further comprises the following substeps:

D21. The master scanning data are obtained by using the divided scanning in the said master scanning mode, namely, Q sections of the master subsection of the scanning data that are obtained through the unrepeatable time division scanning in the master scanning mode make up the said master scanning data. Suppose y=2, 3, . . . , Q, the master subsection scanning cycle used for obtaining the No. y master subsection of scanning data in the said master scanning mode is t_{y}, then:

$${\sum }_{y - 1}^{Q} {t}_{y} = {T}_{P} ;$$

Q sections of the No. ijy subsection of scanning data subframe are obtained through the unrepeatable time subdivision scanning of the No. ij section of the scanning data subframe in the said No. i slave scanning mode. The subsection subframe scanning cycle used for obtaining the said No. ijy subsection of the scanning data subframe is t_{ijy}, then:

$${\sum }_{y = 1}^{Q} {t}_{ijy} = {t}_{ij} ;$$

D22. Suppose i=1, y=1; suppose segmented counting variation for slave scanning as xi, and set x₁=x₂= . . . =x_{N}=1;

D23. y sections of master scanning data are obtained in the master scanning mode after the master subsection scanning cycle t_{y} passes;

D24. Suppose j=xᵢ, the No. ijy subsection of the scanning data subframe is obtained in the No. i slave scanning mode after a subframe scanning cycle t_{ijy}, passes;

D25. Judge whether i equals N;

If i=N, set the value of i as 1 and execute Step D26;

If i≠N, set the value of i+1 as the current value of i and execute Step D24;

D26. Judge whether y equals Q;

If y=Q, set the value of y as 1 and execute Step D27;

If y≠Q, set the value of y+1 as the current value of y and execute Step D23;

D27. Judge whether xᵢ equals Mᵢ;

If xᵢ=Mᵢ, set xᵢ as 1;

If xᵢ≠Mᵢ, set the value of xᵢ+1 as the current value of xᵢ;

D28. Judge whether i equals N;

If i=N, set the value of i as 1 and execute Step D23;

If i≠N, set the value of i+1 as the current value of and execute Step D27.

In addition, when the master scanning mode and slave scanning mode mutually play the chief or standby role or counteract the weakness each other, the following steps are included apart from Step D.

E. When it is needed to change the master scanning mode, the current master scanning mode is set as the slave scanning mode. A slave scanning mode selected is set as the master scanning mode and Step C to Step E are executed.

A case related to the scanning mode is that the said scanning mode as stated in Step A comprises the mutual capacitance scanning mode and mutual capacitance noise detection scanning mode, i.e. N=1. The said mutual capacitance scanning mode refers to a scanning mode where the capacitive touch screen obtains the data on coordinates of the position touched by the touch screen by means of acquiring the mutual capacitance value for the capacitance matrix. The said mutual capacitance noise detection scanning mode refers to the scanning mode where the data processing module for the capacitive touch screen continuously sends two pumping signals at the transmission channel connected to the capacitance matrix and the noise data for the capacitive touch screen is obtained by means of comparing the feedback signals generated by two pumping signals at the receiving channel corresponding to such transmission channel. Or it means a scanning mode where no pump signals are sent by the data processing module for the capacitive touch screen, the noise data for the mutual capacitance touch screen is obtained by comparing the threshold values preset by the signal & data processing modules that are received at the receiving channel connected to the capacitance matrix; the capacitance matrix refers to the mutual capacitance matrix.

Another case with respect to the scanning mode is that the scanning mode as stated in Step A comprises the working scanning mode with the frequency of F₂ and default system calibration scanning mode with the frequency of F₁, i.e. N=1. The said capacitive touch screen takes F₁ as the scanning frequency to obtain the original scanning data which is stored in the memory of such capacitive touch screen. The said default system calibration scanning mode refers to the scanning mode where the scanning data obtained with the scanning frequency of F₁ are compared with the said original scanning data, so as to judge whether the touch of the touch screening is true. The said working scanning mode refers to the scanning mode where the data on coordinates of the position touched by the touch screen with the working frequency of F₂ (F₂≠F₁).

Another case related to the scanning mode is that the said scanning mode as stated in Step A comprises the mutual capacitance scanning mode and self-capacitance scanning mode, i.e. N=1. The said mutual capacitance scanning mode refers to the scanning mode where the data on coordinate of the position touched by the touch screen is obtained when the capacitive touch screen works in the mutual capacitance touch screen mode. The said self-capacitance scanning mode refers to the scanning mode where the data on coordinate of the position touched by the touch screen is obtained when the capacitive touch screen works in the self-capacitance touch screen mode.

Another case related to the scanning mode is that the said scanning mode as stated in Step A comprises the standard electrode width scanning mode and electrode widened width scanning mode, i.e. N=1. The said standard electrode width scanning mode refers to the scanning mode where the data on coordinates of the position touched by the touch screen when the standard width is kept among electrodes of the capacitive touch screen. The said standard electrode widened width scanning mode refers to the scanning mode where the data on coordinates of the position touched by the touch screen when the electrode connecting relation is switched to enable the width among electrodes to exceed the said standard width.

Another case with regard to the scanning mode is that the electromagnetic screen and its data processing modules are additionally mounted to the capacitive touch screen as stated in Step A. The scanning mode as stated in Step A comprises the capacitive screen scanning mode and electromagnetic screen scanning mode, i.e. N=1. The said mutual capacitance scanning mode refers to the scanning mode where the data on coordinate of the position touched by the touch screen is obtained when the capacitive touch screen works in the mutual capacitance touch screen mode or self-capacitance touch screen mode. The said electromagnetic screen scanning mode refers to the scanning mode where the data on coordinate of the position touched by the touch screen is obtained when the electromagnetic screen is enabled and the capacitive touch screen works in the electromagnetic screen mode.

Another case related to the scanning mode is that the said scanning mode as stated in Step A comprises the human touch scanning mode and capacitance pen scanning mode, i.e. N=1. The said human touch scanning mode refers to the scanning mode where the data on coordinates of the position touched by the touch screen when the capacitive touch screen takes human bodies as the sensed touching object. The said capacitance pen scanning mode refers to the scanning mode where the data on coordinates of the position touched by the touch screen when the capacitive touch screen takes capacitance pens as the sensed touching object.

Compared to the existing technology, technical effect of the invention entitled “A time slot scanning mode enabling the capacitive touch screen to execute multiple scanning modes” is that:

1. Through the alternate use of the master scanning mode and slave scanning mode, the present invention is able to simultaneously acquire the master scanning data and slave scanning data, thus the strengths of the master scanning and slave scanning are utilized to solve the issue that fails to be resolve by only one scanning mode used. In the meantime, the alternate use of the master scanning mode and slave scanning mode ensures the homogeneity of the data acquisition time, thus enabling the reliability of data; only part of the slave scanning mode is executed, so as to minimize the additional time consumption;

2. Multiple scanning modes are executed in parallel. The slave scanning mode provides detection data for the master scanning mode, thus ensuring the stable running of the touch screen and effectively suppressing noises;

3. Multiple scanning modes are executed in parallel, enabling the slave scanning mode to provide backup for the master scanning mode. Through the switching between the master scanning mode and slave scanning mode, shortcomings can be mutually counteracted between the master scanning mode and slave scanning mode, thus eliminating the influences upon the special touch areas of the touch screen and ensuring the accuracy of data;

4. Multiple scanning modes are executed in parallel, so as to facilitate the rapid switching of two scanning modes and their hardware circuits or software parameters, thus enabling the touch screen to be suitable for multiple application demands.

### DESCRIPTION OF FIGURES

FIG. 1 is the data structure sketch map on the No. 1 slave scanning data for the first embodiment of the present invention entitled “A Time Slot Scanning Method Enabling the Capacitive Touch Screen to Implement Multiple Scanning Modes”;

FIG. 2 is the data structure sketch map on the No. 2 slave scanning data for the said second embodiment;

FIG. 3 is the data structure sketch map on the said first embodiment where multiple scanning modes are executed;

FIG. 4 is the data structure sketch map on the second embodiment of the present invention concerning the master scanning data;

FIG. 5 is the data structure sketch map on the No. 1 slave scanning data for the said second embodiment;

FIG. 6 is the data structure sketch map on the No. 2 slave scanning data for the said second embodiment;

FIG. 7 is the data structure sketch map on the said second embodiment where multiple scanning modes are executed.

### MODE OF CARRYING OUT THE INVENTION MODEL

To further illustrate the principle and structure of the invention, the invention is further described in detail in accordance with the preferable embodiments shown in the figures.

The present invention proposes a time slot scanning method enabling the capacitive touch screen to implement multiple scanning modes is executed. The said capacitive touch screen comprises the capacitance matrix and the data processing module electrically connected thereto. The said scanning mode refers to the data acquisition mode where the signal scanning is initiated in a cycle and the received data generated due to scanning are acquired. The said method comprises the following steps:

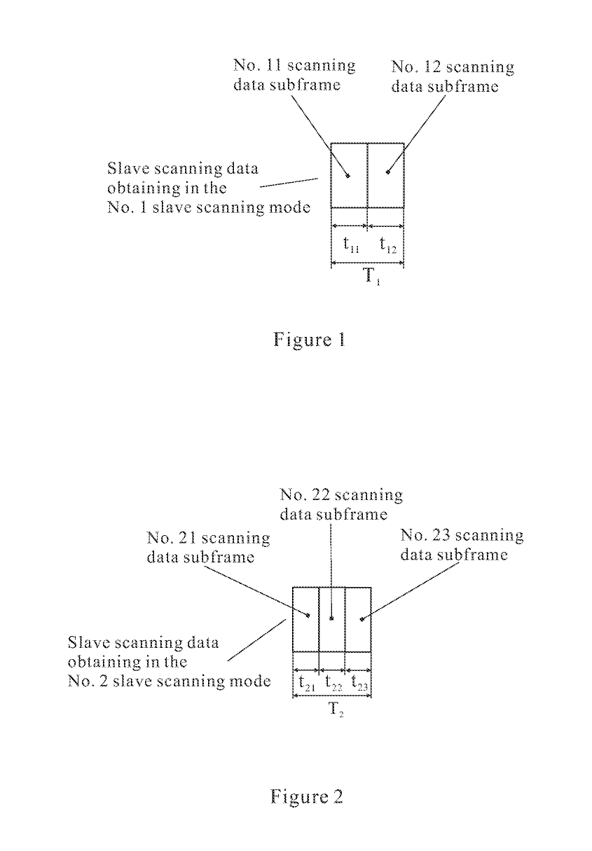

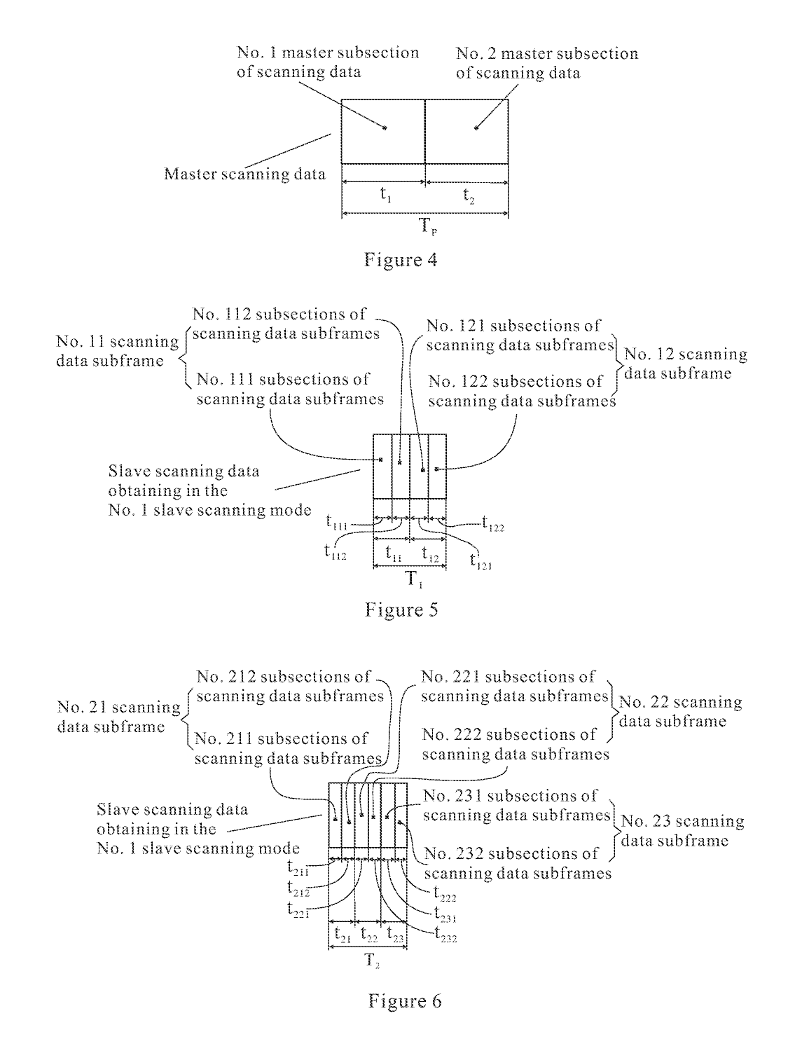

A. The said capacitive touch screen is equipped with hardware and software, enabling such capacitive touch screen to support the completion of N+1 scanning modes, N≧1; as can be shown in FIG. 1-7, in the first and second embodiments of the present invention, three scanning modes are adopted, i.e. N=2;

B. One of N+1 scanning modes as stated in Step A is chosen to be set as the master scanning mode for the said touch screen, and other scanning modes thereof are respectively set as No. 1 slave scanning mode, No. 2 slave scanning mode . . . No. N slave scanning mode;

The said master scanning mode obtains a master scanning data frame in its own master scanning cycle T_{P}; the said various slave scanning modes respectively obtain a slave scanning data frame in their respective own slave scanning cycles T₁, T₂, . . . , T_{N};

In the first and second embodiments of the present invention, the scanning modes of the said touch screen is set as the master scanning mode, along with the No. 1 slave scanning mode and No. 2 slave scanning mode;

C. The divided scanning is used to enable various slave scanning modes to obtain their respective slave scanning data, namely, the Mi section of scanning data subframes that are obtained through the unrepeatable time division scanning in the No. i slave scanning mode make up the No. i slave scanning data, i=1, 2, . . . , N. Mᵢ represents the quantity of scanning data subframes for the No. i slave scanning mode, Mᵢ≧1; suppose j=1, 2, . . . , Mi, the subframe scanning cycle used for obtaining the No. ij scanning data subframe in the No. i slave scanning mode is tᵢⱼ, then:

$${\sum }_{j = 1}^{{M}_{i}} {t}_{ij} = {T}_{i} ;$$

the variation i reflects the serial number of the slave scanning mode, while the variation j reflects the serial number of the scanning data subframe belonging to the same slave scanning data;

As can be shown in FIG. 1-2 and FIG. 5-6, in the first and second embodiments of the present invention, the said No. 1 slave scanning data comprise the No. 11 scanning data subframe and No. 12 scanning data subframe, i.e., M₁=2. The said No. 2 slave scanning data comprise the No. 21 scanning data subframe, No. 22 scanning data subframe and No. 23 scanning data subframe, i.e. M₂=3;

The said unrepeatable scanning means that various subframe scanning cycles tij do not overlap and there are no intervals between two adjacent subframe scanning cycles, then: t₁₁+t₁₂=T₁, t₂₁+t₂₂+t₂₃=T₂.

D. In a scanning cycle T, a master scanning data frame is obtained in a master scanning cycle TP. And the respective sections of the No. ij subframe scanning cycle tij for various slave scanning modes are used to obtain N No. ij scanning data subframes. i.e. T=T_{P}+t₁ⱼ+t₂ⱼ+ . . . +t_{Nj}; that is to say, as for the No. i slave scanning mode, both the Mi master data frames and a No. i slave scanning data frame are obtained after Mi scanning cycles T have passed.

The aforementioned Step D in the first embodiment of the present invention has completed a process of a scanning cycle T, namely, the time slot scanning mode means that the slave scanning mode of the executed part is inserted between two master scanning modes. The said Step D further comprises the following substeps:

D1. In a scanning cycle T, first a master scanning data frame is obtained in a master scanning cycle T_{P}, and then N No. ij scanning data subframes are obtained in the respective sections of subframe scanning cycles tij for various slave scanning modes.

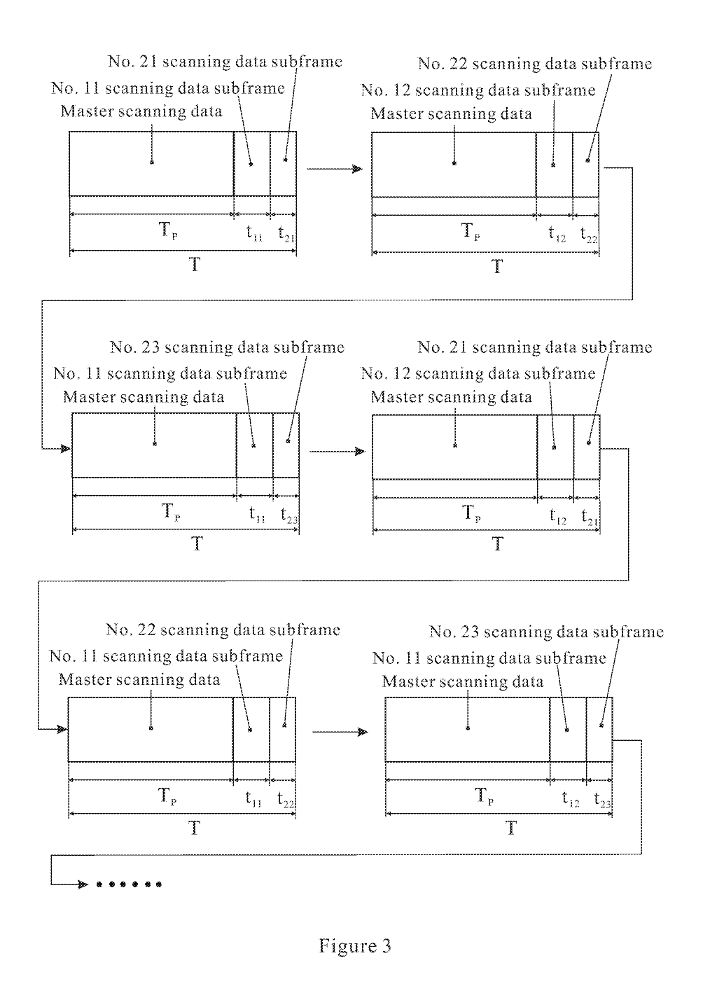

As is shown in FIG. 3, in the first embodiment of the present invention, the said Substep D1 further comprises the following substeps:

D11. Suppose i=1 and the divided counting variation for slave scanning as xi, and set x₁=x₂= . . . =x_{N}=1;

D12. A master scanning data frame is obtained by using the master scanning mode after a master scanning cycle T_{P} passes;

D13. Suppose j=xᵢ the No. ij scanning data subframe is obtained in the No. i slave scanning mode after a subframe scanning cycle tij passes.

D14. Judge whether xi equals Mi;

If xᵢ=Mᵢ, set xᵢ as 1;

If xᵢ≠Mᵢ, set the value of xᵢ+1 as the current value of xᵢ;

D15. Judge whether i equals N;

If i=N, set the value of i as 1 and execute Step D12;

If i≠N, set the value of i+1 as the current value of and execute Step D13.

The divided technical variation xi is used to count the serial numbers of the subframe scanning data belong to various slave scanning data. Step D14 is used for updating various values of xᵢ. Step D15 is used for completing two nested loops. The internal loops in Step D13 to Step D15 are used to complete the scanning data subframe of various slave scanning modes. The external loops in Step D12 to Step D15 are utilized to complete a scanning cycle T.

The aforementioned Step D in the second embodiment of the present invention has completed a process of a scanning cycle T, namely, the time slot scanning mode means that the time slots are set in the course of executing the master scanning mode in a cycle and the slave scanning mode of the executed part is inserted into the time slot. The said Step D further comprises the following substeps:

D2. The master scanning data are obtained by using the divided scanning in the said master scanning mode, thus enabling the composition of the master subsection of scanning data completed by Q sections of master subsection scanning cycles; the composition of various scanning data subframes can also be achieved through the subdivided scanning, enabling the composition of the scanning data subframe completed by the subsection subframe scanning cycle for the No. ij scanning data subframe;

In a scanning cycle T, the following processes are executed in cycles for Q times:

First a master subsection of scanning data is obtained in the master subsection scanning cycle, and then N subsections of scanning data subframes are obtained in respective sections of subframe scanning cycles for various subscanning modes.

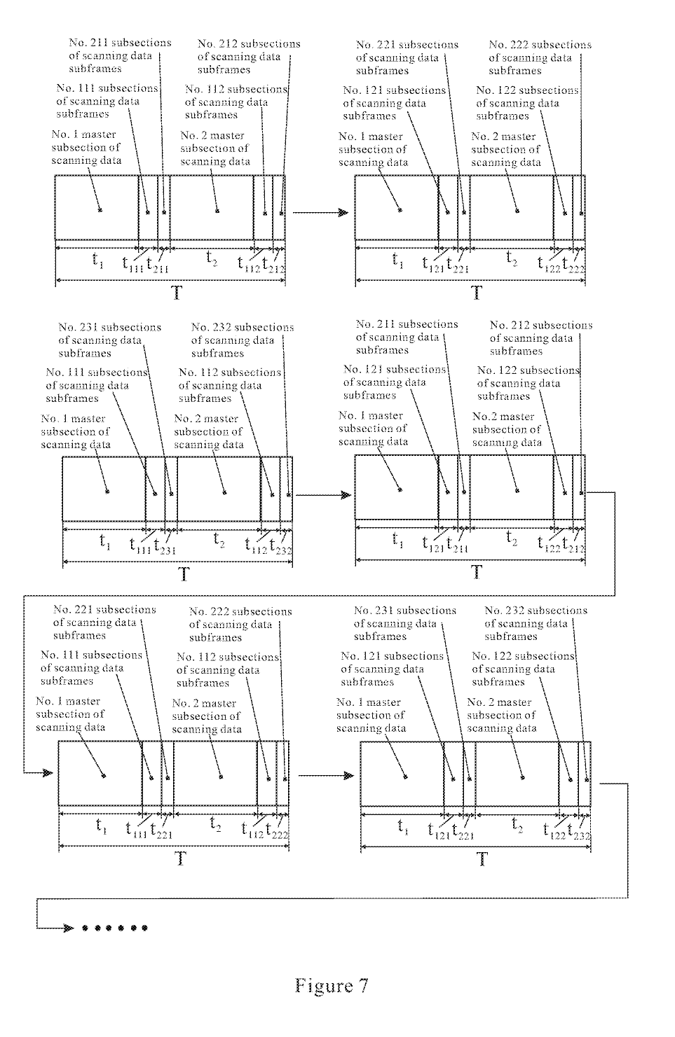

As can be shown in FIG. 7, in the second embodiment of the present invention, the said Substep D2 further comprises the following substeps:

D21. The master scanning data are obtained by using the divided scanning in the said master scanning mode, namely, Q sections of the master subsection of the scanning data that are obtained through the unrepeatable time division scanning of the master scanning mode make up the said master scanning data. Suppose y=2, 3, . . . , Q, the master subsection scanning cycle used for obtaining the No. y master subsection of scanning data in the said master scanning mode is t_{y}, then:

$${\sum }_{y = 1}^{Q} {t}_{y} = {T}_{P} ;$$

Q sections of the No. ijy subsection of the scanning data subframe is obtained through the unrepeatable time subdivision scanning of the No. ij section of the scanning data subframe in the said No. i slave scanning mode. The subsection subframe scanning cycle used for obtaining the said No. ijy subsection of the scanning data subframe is t_{ijy}, then:

$${\sum }_{y = 1}^{Q} {t}_{ijy} = {t}_{ij} ;$$

D22. Suppose i=1, y=1; suppose the segmented counting variation for slave scanning as xᵢ, and set x₁=x₂= . . . =x_{N}=1;

D23. y section(s) of master scanning data is obtained in the master scanning mode after the master subsection scanning cycle t_{y} passes;

D24. Suppose j=xᵢ, the No. ijy subsection of the scanning data subframe is obtained in the No. i slave scanning mode after a subframe scanning cycle t_{ijy} passes;

D25. Judge whether i equals N;

If i=N, set the value of i as 1 and execute Step D26;

If set the value of i+1 as the current value of i and execute Step D24;

D26. Judge whether y equals Q;

If y=Q, set the value of y as 1 and execute Step D27;

If y≠Q, set the value of y+1 as the current value of y and execute Step D23;

D27. Judge whether xi equals Mi;

If xᵢ=Mᵢ, set xᵢ as 1;

If xᵢ≠Mᵢ, set the value of xᵢ+1 as the current value of xi;

D28. Judge whether i equals N;

If i=N, set the value of i as 1 and execute Step D23;

If i≠N, set the value of i+1 as the current value of and execute Step D27.

It is thus evident from above-mentioned steps that the second embodiment of the present invention is more complicated than the first embodiment in terms of scanning control, but the time for adopting various scanning modes of the second embodiment are more homogeneous.

In addition, when the master scanning mode and slave scanning mode mutually play the chief or standby role or counteract the weakness each other, the following steps are included apart from Step D.

E. When it is needed to change the master scanning mode, the current master scanning mode is set as the slave scanning mode. A slave scanning mode selected is set as the master scanning mode and Step C to Step E are executed.

Here below the combination of various specific scanning modes are used to dwell on the effects exerted by the present invention proposal upon actual applications.

There is an application where the noise detection scanning mode is run based on the master scanning mode. The scanning mode as stated in Step A comprises the mutual capacitance scanning mode and mutual capacitance noise detection scanning mode, i.e. N=1. The said mutual capacitance scanning mode refers to a scanning mode where the capacitive touch screen obtains the data on coordinates of the position touched by the touch screen by means of acquiring the mutual capacitance value for the capacitance matrix. The said mutual capacitance noise detection scanning mode refers to the scanning mode where the data processing module for the capacitive touch screen continuously sends two pumping signals at the transmission channel connected to the capacitance matrix and the noise data for the capacitive touch screen is obtained by means of comparing the feedback signals generated by two pumping signals at the receiving channel corresponding to such transmission channel. Or it means a scanning mode where no pump signals are sent by the data processing module for the capacitive touch screen, the noise data for the mutual capacitance touch screen is obtained by comparing the threshold values preset by the signal & data processing modules that are received at the receiving channel connected to the capacitance matrix; the capacitance matrix refers to the mutual capacitance matrix. In this application, the mater scanning is the normal scanning of mutual capacitance. An original data frame for the capacitive screen can be obtained in each scanning. The No. 1 slave scanning is the mutual capacitance noise detection scanning mode. This application combines the mode of the first embodiment for the present invention, namely, part of the No. 1 slave scanning is inserted between two adjacent master scanning modes. Only part of the No. 1 slave scanning data frame in each scanning cycle is prepared, but each time it is not repeated. For example, in the first scanning cycle, the scanning data subframe are the first 1/R part of the No. 1 slave scanning data; in the second scanning cycle, the subframe scanning data are the second 1/R part of the No. 1 slave scanning data; till the No. R scanning cycle, a complete No. 1 slave scanning data frame is finished. The said mutual capacitance noise detection scanning mode is different from the mutual capacitance scanning mode as the master scanning mode. When the master scanning mode adopts the normal scanning mode of mutual capacitance, signals are sent in turn at each transmission channel for the data processing module in a master scanning cycle TP, and signals are received at each receiving channel. At some moment only one transmission channel sends signals. When the transmission in all channels is finished and the data sent by the last transmission channel is received by the reception channel, the scanning of a complete master scanning data frame is finished. The mutual capacitance noise detection scanning method is used to detect external noises occurring in the current capacitive screen. In respect of noise detection, two signal transmissions in a row at one transmission channel can be performed. Through comparing the receiving signals at the receiving channel corresponding to two signal transmissions, if the two transmission signals at the transmission channel are different from the receiving signals at corresponding receiving channels, it is perceived to have noises. Or signals are directly received at the receiving channel rather than being transmitted at the transmission channel. In such case, if the signals received at the receiving channels exceed a preset threshold, it will be perceived to have noises. Obviously, the configurations for the mutual capacitance noise detection scanning mode and mutual capacitance scanning mode are different. After a complete frame of the normal scanning mode is finished, 1/R mutual capacitance noise detection scanning mode will be performed. After N cycles pass, a noise data frame can be obtained. The noise data can thereby be obtained while the mutual capacitance scanning mode is performed, thus facilitating the corresponding processing of the system. As each scanning cycle T represents the master scanning cycle TP and a No. 1 slave scanning cycle T1/R, the total cycle for the touch screen T still remains even, which fails to affect the normal working of the master scanning. In this application, when the time slot insertion mode for the second embodiment of the present invention is adopted, each time the time for completing the mutual capacitance detection scanning mode is shortened, the undetectable probability for the presence of noises is further reduced.

It is an application where the default system scanning mode acts as the slave scanning. The scanning mode as stated in Step A comprises the working scanning mode with the frequency of F2 and the default system calibration scanning mode with the frequency of F1, i.e. N=1. The said capacitive touch screen takes F1 as the scanning frequency to obtain the original scanning data which is stored in the memory of such capacitive touch screen. The said default system calibration scanning mode refers to the scanning mode where the scanning data obtained with the scanning frequency of F1 are compared with the said original scanning data, so as to judge whether the touch of the touch screening is true. The said working scanning mode refers to the scanning mode where the data on coordinates of the position touched by the touch screen with the working frequency of F2 (F2≠F1). In this application, the frequency F1 represents the system calibration frequency. When products are delivered away from the factory for detection, original data obtained by using scanning at the frequency F1 are saved as the calibration base data, which are used for the auxiliary judgment of numerical values in the course of subsequent application. For instance, the mode of using base/differential values is adopted to judge the touch. When the higher differential values are stably present, in the meantime the deviation of the original data from the calibration base can be viewed. If deviations at each point are very identical, it tends to be perceived as the current wrong touch. This differential value can be perceived to be incurred by the error of the calibration base. The calibration base can be corrected; if these deviations are not identical at individual area, it is inclined to perceive that such touch is true. When the scanning mode at the working frequency of F2 is adopted, it is meaningless to compare the original data obtained in the working scanning mode at the frequency of F2 with the calibration data base at the frequency of F1. In such case, the original calibration data can be obtained in the default system calibration scanning mode at the frequency of F1. Such data can still be compared with the calibration base obtained at the frequency of F1 saved in the touch screen to judge where the stable differential value is true touch.

It is an application that is compatible with the mutual capacitance scanning mode and self-capacitance scanning mode. The scanning mode as stated in Step A comprises the mutual capacitance scanning mode and self-capacitance scanning mode, i.e. N=1. The said mutual capacitance scanning mode refers to the scanning mode where the data on coordinate of the position touched by the touch screen is obtained when the capacitive touch screen works in the mutual capacitance touch screen mode. The said self-capacitance scanning mode refers to the scanning mode where the data on coordinate of the position touched by the touch screen is obtained when the capacitive touch screen works in the self-capacitance touch screen mode. As regards the mutual capacitance scanning mode, it has a higher signal to noise ratio and no “ghost points”, enabling good true multi-point touch. In some cases, the problem such as “remanent points” or noise disturbance can occur in the mutual capacitance scanning mode. Under the same conditions, no disturbance will occur in the self-capacitance scanning mode, though the self-capacitance scanning mode has a lower signal to noise ratio than the mutual capacitance scanning mode does and fails to enable the true multi-point touch due to the presence of “ghost points”. When the self-capacitance scanning mode acts as the slave scanning, a touch area can be viewed whether it has “remanent points” or “noises” by means of the self-capacitance data, thus removing such influences. If the mutual capacitance scanning mode fails to normally work by reason of influences exerted by noises, the master scanning and slave scanning can be switched as per Step E, where the self-capacitance scanning mode acts as the master scanning and the mutual capacitance scanning mode as the slave scanning. When the self-capacitance scanning mode detects multiple points which are hard to be judged, the data obtained in the mutual capacitance scanning mode can be used to view the general position of true touch points, thus eliminating influences of “ghost points”. In this application, the slave scanning mode is used to counteract defects of the master scanning mode.

It is an application where the connecting relation is changed in a real-time manner. The scanning mode as stated in Step A comprises the standard electrode width scanning mode and electrode widened width scanning mode, i.e. N=1. The said standard electrode width scanning mode refers to the scanning mode where the data on coordinates of the position touched by the touch screen when the standard width is kept among electrodes of the capacitive touch screen. The said standard electrode widened width scanning mode refers to the scanning mode where the data on coordinates of the position touched by the touch screen when the electrode connecting relation is switched to enable the width among electrodes to exceed the said standard width. In this application, the width for electrodes corresponding to the standard electrode width scanning mode is very low, while the electrode width corresponding to the electrode width widened scanning mode can change the electrode width into twice of the standard electrode scanning mode by means of two electrode short circuits. The pitch for the standard electrode width scanning mode is very low, which can enable high precision and sensitivity. In hanging conditions, the relative area of fingers is higher and will behave as float conductors. The touch sensitivity will obviously fall. In respect of the electrode width widened scanning mode, adjacent electrodes are short circuited. Therefore, corresponding pitches are equivalent to twice of the master scanning mode. The relative area of fingers become smaller, which will be less influenced by hanging conditions. The touch can still be identified in hanging conditions. In this application, the slave scanning mode is used to counteract defects of the master scanning mode.

It is an application where the touch screen type is changed. The electromagnetic screen and its data processing modules are additionally mounted to the capacitive touch screen as stated in Step A. The scanning mode as stated in Step A comprises the capacitive screen scanning mode and electromagnetic screen scanning mode, i.e. N=1. The said capacitive screen scanning mode refers to the scanning mode where the data on coordinate of the position touched by the touch screen is obtained when the capacitive screen is enabled and the capacitive touch screen works in the capacitive screen mode. The said electromagnetic screen scanning mode refers to the scanning mode where the data on coordinate of the position touched by the touch screen is obtained when the electromagnetic screen is enabled and the capacitive touch screen works in the electromagnetic screen mode. In this application, the said touch screen means the combination of the capacitive screen and electromagnetic screen. Because of restrictions in terms of physical attributes, the capacitive screen and electromagnetic screen cannot be simultaneously used. In this application, the capacitive screen scanning mode acts as the master scanning and the electromagnetic screen scanning mode as the slave scanning. If the electromagnetic pen is detected to perform the touch, the electromagnetic scanning mode will immediately be used as the master scanning mode as per Step E, and the capacitive screen scanning mode as the slave scanning mode. If the electromagnetic pen is detected to rise, the capacitive screen scanning mode will act as the master scanning and the electromagnetic scanning mode as the slave scanning mode. In this application, the real-time switching for the scanning mode is achieved.

It is an application where the scanning mode changes with the change of touched objects. The scanning mode as stated in Step A comprises the human touch scanning mode and capacitance pen scanning mode, i.e. N=1. The said human touch scanning mode refers to the scanning mode where the data on coordinates of the position touched by the touch screen when the capacitive touch screen takes human bodies as the sensed touching object. The said capacitance pen scanning mode refers to the scanning mode where the data on coordinates of the position touched by the touch screen when the capacitive touch screen takes capacitance pens as the sensed touching object. In this application, the said touch screen can not only regard fingers as the detection object, but also takes the capacitance pen transmitting some frequency as the detection object. The scanning modes for detecting fingers and the capacitance pen are different. Therefore, both of them cannot simultaneously be used at some moment. The human touch scanning mode detecting fingers acts as the master scanning mode and the capacitance pen scanning mode as the slave scanning mode. If the capacitance pen is spotted to touch the touch screen, the capacitance pen will immediately be changed as the master scanning and the human touch scanning mode as the slave scanning mode. If the capacitance pen is spotted to rise, the human touch scanning mode will be reused as the master scanning mode and the capacitance pen scanning mode as the slave scanning mode. This application is anther embodiment of the real-time switching for the scanning mode.

What is claimed is:

1. A time slot scanning method enabling the capacitive touch screen to implement multiple scanning modes, where the said capacitive touch screen comprises the capacitance matrix and data processing modules that are electrically connected thereto; the said scanning method refers to a data acquisition mode where the signal scanning is initiated in a cycle and the received data generated due to scanning are acquired; the said method is characterized in that it comprises the following steps:
A. The said capacitive touch screen is equipped with hardware and software, enabling it to support the completion of multiple N+1 scanning modes, N≧1;
B. One of N+1 scanning modes as stated in Step A is chosen to be set as the master scanning mode for the said touch screen, and other scanning modes thereof are respectively set as No. 1 slave scanning mode, No. 2 slave scanning mode . . . No. N slave scanning mode;
The said master scanning mode obtains a master scanning data frame in its own master scanning cycle T_{P}; the said various slave scanning modes respectively obtain a slave scanning data frame in their respective own slave scanning cycles T₁, T₂, . . . , T_{N};
C. The divided scanning is used to enable various slave scanning modes to obtain their respective slave scanning data, namely, the Mi section of the scanning data subframes that are obtained through the unrepeatable time division scanning in the No. i slave scanning mode make up the No. i slave scanning data, i=1, 2, . . . , N; Mi represents the quantity of scanning data subframes for the No. i slave scanning mode, Mi≧1; Suppose j=1, 2, . . . , Mi, the subframe scanning cycle used for obtaining the No. ij scanning data subframe in the No. i slave scanning mode is tij, then:
$${\sum }_{j = 1}^{{M}_{i}} {t}_{ij} = {T}_{i} ;$$
D. In a scanning cycle T, a master scanning data frame is obtained in a master scanning cycle T_{P}, and the respective sections of the No. ij subframe scanning cycle tij for various slave scanning modes are used to obtain N No. ij scanning data subframes. i.e. T=T_{P}+t₁ⱼ+t₂ⱼ+ . . . +t_{Nj}; that is to say, as for the No. i slave scanning mode, both the Mi master data frames and a No. i slave scanning data frame are obtained after Mi scanning cycles T have passed.

2. The time slot scanning method enabling the capacitive touch screen to implement multiple scanning modes according to claim 1 is characterized in that:
The said Step D further comprises the following substeps:
D1. In a scanning cycle T, first a master scanning data frame is obtained in a master scanning cycle T_{P}, and then N No. ij scanning data subframes are obtained in the respective sections of the subframe scanning cycle tij for various slave scanning modes.

3. The time slot scanning method enabling the capacitive touch screen to implement multiple scanning modes according to claim 2 is characterized in that:
The said substep D1 further comprises the following substeps:
D11. Suppose i=1 and the divided counting variation for slave scanning as xᵢ, and set x₁=x₂= . . . =x_{N}=1;
D12. A master scanning data frame is obtained in the master scanning mode after a master scanning cycle T_{P} passes;
D13. Suppose j=xᵢ, the No. ij scanning data subframe is obtained in the No. i slave scanning mode after a subframe scanning cycle tᵢⱼ passes.
D14. Judge whether xᵢ equals Mᵢ;
If xᵢ=Mᵢ, set xᵢ as 1;
If xᵢ≠Mᵢ, set the value of xᵢ+1 as the current value of xᵢ;
D15. Judge whether i equals N;
If i=N, set the value of i as 1 and execute Step D12;
If i≠N, set the value of i+1 as the current value of I and execute Step D13.

4. The time slot scanning method enabling the capacitive touch screen to implement multiple scanning modes according to claim 1 is characterized in that:
The said Step D further comprises the following substeps:
D2. The master scanning data are obtained by using the divided scanning in the said master scanning mode, thus enabling the composition of the master subsection of scanning data completed by Q sections of master subsection scanning cycles; the composition of various scanning data subframes can also be achieved through the subdivided scanning, enabling the composition of the scanning data subframe completed by the subsection subframe scanning cycle for the No. ij scanning data subframe;
In a scanning cycle T, the following processes are executed in cycles for Q times,
first a master subsection of scanning data is obtained in the master subsection scanning cycle, and then N subsections of scanning data subframes are obtained in the respective subsections of subframe scanning cycles for various subscanning modes.

5. The time slot scanning method enabling the capacitive touch screen to implement multiple scanning modes according to claim 1 is characterized in that:
The said Step D2 further comprises the following substeps:
D21. The master scanning data are obtained by using the divided scanning in the said master scanning mode, namely, Q sections of the master subsection of the scanning data that are obtained through the unrepeatable time division scanning of the master scanning mode make up the said master scanning data; suppose y=2, 3, . . . , Q, the master subsection scanning cycle used for obtaining the No. y master subsection of scanning data in the said master scanning mode is t_{y}, then:
$${\sum }_{y = 1}^{Q} {t}_{y} = {T}_{P} ;$$
Q sections of No. ijy subsection of the scanning data subframe is obtained through the unrepeatable time subdivision scanning of the No. ij section of the scanning data subframe in the said No. i slave scanning mode; the subsection subframe scanning cycle used for obtaining the said No. ijy subsection of the scanning data subframe is t_{ijy}, then:
$${\sum }_{y = 1}^{Q} {t}_{ijy} = {t}_{ij} ;$$
D22. Suppose i=1, y=1; suppose divided counting variation for slave scanning as xᵢ, and set x₁=x₂= . . . =x_{N}=1;
D23. y sections of master scanning data are obtained in the master scanning mode after the master subsection scanning cycle t_{ijy} passes;
D24. Suppose j=xᵢ, the No. ijy subsection of the scanning data subframe is obtained in the No. i slave scanning mode after a subframe scanning cycle t_{ijy} passes;
D25. Judge whether i equals N;
If i=N, set the value of i as 1 and execute Step D26;
If i≠N, set the value of i+1 as the current value of i and execute Step D24;
D26. Judge whether y equals Q;
If y=Q, set the value of y as 1 and execute Step D27;
If y≠Q, set the value of y+1 as the current value of y and execute Step D23;
D27. Judge whether xᵢ equals Mᵢ;
If xᵢ=Mᵢ, set xᵢ as 1;
If xᵢ≠Mᵢ, set the value of xᵢ+1 as the current value of xᵢ;
D28. Judge whether i equals N;
If i=N, set the value of i as 1 and execute Step D23;
If i≠N, set the value of i+1 as the current value of and execute Step D27.

6. The time slot scanning method enabling the capacitive touch screen to implement multiple scanning modes according to claim 1 is characterized in that:
Apart from Step D, the following steps are included:
E. When it is needed to change the master scanning mode, the current master scanning mode is set as the slave scanning mode; A slave scanning mode selected is set as the master scanning mode and Step C to Step E are executed.

7. The time slot scanning method enabling the capacitive touch screen to implement multiple scanning modes according to claim 1 is characterized in that:
the scanning mode as stated in Step A comprises the mutual capacitance scanning mode and mutual capacitance noise detection scanning mode, i.e. N=1;
the said mutual capacitance scanning mode refers to a scanning mode where the capacitive touch screen obtains the data on coordinates of the position touched by the touch screen by means of acquiring the mutual capacitance value for the capacitance matrix;
the said mutual capacitance noise detection scanning mode refers to the scanning mode where the data processing module for the capacitive touch screen continuously sends two pumping signals at the transmission channel connected to the capacitance matrix and the noise data for the capacitive touch screen is obtained by means of comparing the feedback signals generated by two pumping signals at the receiving channel corresponding to such transmission channel; or it means a scanning mode where no pump signals are sent by the data processing module for the capacitive touch screen, the noise data for the mutual capacitance touch screen is obtained by comparing the threshold values preset by the signal & data processing modules that are received at the receiving channel connected to the capacitance matrix; the capacitance matrix refers to the mutual capacitance matrix.

8. The time slot scanning method enabling the capacitive touch screen to implement multiple scanning modes according to claim 1 is characterized in that:
the scanning mode as stated in Step A comprises the working scanning mode with the frequency of F₂ and the default system calibration scanning mode with the frequency of F₁, i.e. N=1;
the said capacitive touch screen takes F₁ as the scanning frequency to obtain the original scanning data which is stored in the memory of such capacitive touch screen;
the said default system calibration scanning mode refers to the scanning mode where the scanning data obtained with the scanning frequency of F₁ are compared with the said original scanning data, so as to judge whether the touch of the touch screening is true;
the said working scanning mode refers to the scanning mode where the data on coordinates of the position touched by the touch screen with the working frequency of F₂ (F₂≠F₁).

9. The time slot scanning method enabling the capacitive touch screen to implement multiple scanning modes according to claim 1 is characterized in that:
the scanning mode as stated in Step A comprises the mutual capacitance scanning mode and self-capacitance scanning mode, i.e. N=1;
the said mutual capacitance scanning mode refers to the scanning mode where the data on coordinate of the position touched by the touch screen is obtained when the capacitive touch screen works in the mutual capacitance touch screen mode;
the said self-capacitance scanning mode refers to the scanning mode where the data on coordinate of the position touched by the touch screen is obtained when the capacitive touch screen works in the self-capacitance touch screen mode.

10. The time slot scanning method enabling the capacitive touch screen to implement multiple scanning modes according to claim 1 is characterized in that:
the scanning mode as stated in Step A comprises the standard electrode width scanning mode and electrode widened width scanning mode, i.e. N=1;
the said standard electrode width scanning mode refers to the scanning mode where the data on coordinates of the position touched by the touch screen when the standard width is kept among electrodes of the capacitive touch screen;
the said standard electrode widened width scanning mode refers to the scanning mode where the data on coordinates of the position touched by the touch screen when the electrode connecting relation is switched to enable the width among electrodes to exceed the said standard width.

11. The time slot scanning method enabling the capacitive touch screen to implement multiple scanning modes according to claim 1 is characterized in that:
the electromagnetic screen and its data processing modules are additionally mounted to the capacitive touch screen as stated in Step A; the scanning mode as stated in Step A comprises the capacitive screen scanning mode and electromagnetic screen scanning mode, i.e. N=1;
the said mutual capacitance scanning mode refers to the scanning mode where the data on coordinate of the position touched by the touch screen is obtained when the capacitive touch screen works in the mutual capacitance touch screen mode or self-capacitance touch screen mode;
the said electromagnetic screen scanning mode refers to the scanning mode where the data on coordinate of the position touched by the touch screen is obtained when the electromagnetic screen is enabled and the capacitive touch screen works in the electromagnetic screen mode.

12. The time slot scanning method enabling the capacitive touch screen to implement multiple scanning modes according to claim 1 is characterized in that:
the scanning mode as stated in Step A comprises the human touch scanning mode and capacitance pen scanning mode, i.e. N=1;
the said human touch scanning mode refers to the scanning mode where the data on coordinates of the position touched by the touch screen when the capacitive touch screen takes human bodies as the sensed touching object;
the said capacitance pen scanning mode refers to the scanning mode where the data on coordinates of the position touched by the touch screen when the capacitive touch screen takes capacitance pens as the sensed touching object.
